(19) United States
(12) Patent Application Publication
(10) Pub. No.: US 2015/0053148 A1
(43) Pub. Date: Feb. 26, 2015

(54) PET SOCKS AND MANUFACTURING METHOD THEREOF

(71) Applicant: ZHUJI LONGBOW KNITTING CO., LTD., Zheijiang (CN)

(72) Inventor: Jianfeng Huang, Zhejiang (CN)

(21) Appl. No.: 14/385,902

(22) PCT Filed: Mar. 20, 2013
(86) PCT No.: PCT/CN2013/072964

§ 371 Date: Sep. 17, 2014

(30) Foreign Application Priority Data
Mar. 20, 2012 (CN) 201220106930.1
Dec. 5, 2012 (CN) 201210525423.6
Dec. 5, 2012 (CN) 201220666583.8
Mar. 18, 2013 (CN) 201320124119.0

(51) Int. Cl. A01K 13/00; D06B 1/00; D03D 1/00

(52) U.S. Cl. CPC A01K 13/007; D03D 1/00; D06B 1/00
USPC 119/850; 28/143; 28/169

(57) ABSTRACT

The present invention relates to pet sock and a manufacturing method thereof, relating to the technical field of pet supplies. The present invention has solved the technical problems in the prior arts and provides a much more reasonable design. The pet sock provided by the present invention each comprises a sock body, a sock bottom for accommodating a foot of a pet which is communicated with the sock body, and a sock opening for a foot of a pet to get in or out being provided on the sock body, the pet sock being characterized in that an elastic waterproof layer made of elastic waterproof material is compounded on an outer side of the sole of the sock bottom. Compared with the prior arts, the pet sock and the manufacturing method thereof have the following advantages: the design of the pet sock is much more rational and the structure thereof is simpler; as an anti-slide-off structure is provided, the sock can be secured onto the leg of the pet and are unlikely to slide off; meanwhile, due to the arrangement of a shield sleeve, the anti-slide-off structure can be shielded, so that the pet sock look more beautiful and become warmer; in addition, the arrangement of the elastic waterproof layer can provide much more comfort and protect the feet of pets from injuries.

### TECHNICAL FIELD

The present invention relates to a pet sock and a manufacturing method thereof, belonging to the technical field of pet supplies.

### BACKGROUND OF THE INVENTION

As the living standards of people increase gradually, more and more people keep pets. However, there are some problems presented during the raising of pets, regardless of cats and dogs. For example, both paws and claws of pets carry various bacteria which accumulate gradually when pets step on roads, grass lands and mud grounds or even pass by dirtier environments, causing health problems to pets. In addition, it is inevitable for pets to touch dust, mud, garbage or other dirt when passing by those places mentioned above. After pets go back home, such dirt and viruses will be spread everywhere while they play in the house. As a result, a clean environment is impossible. Kids and adults may be exposed to such dirt and bacteria when they play with their pets. This will cause certain harm to human health.

Certainly, the above problem may be solved by cleaning the feet of pets.

However, problems like the following still exist: first, the cleaning process is time and labor-consuming; furthermore, not all owners will clean their pets every time they go back home, and those cleaning their pets frequently may fail to clean their pets in special circumstances; second, if pets are not wiped up after being cleaned, footprints of pets may be left on the floor when they walk; third, in cold seasons, pets will feel cold when their feet touch the floor; and fourth, the sharp claws of pets could injure people, especially kids; in addition, their sharp claws may damage clothes of the people, wooden floor, furniture, etc.

To solve the above problems, people have made long-term exploration. For example, a Chinese patent application with the publication number of CN 201020222123.7 disclosed a pet health-care sock, wherein plastic anti-skid points are additionally provided both in the toe and paw regions on both front and back sides of the sock bottom. The distribution of the plastic anti-skid points both in the toe and paw regions of the sock bottom may increase friction to prevent the pets from injuries caused by slipping, while keeping the pets warmer and reducing the damages to people and indoor articles by the pets. The plastic anti-skid points, provided on a side in contact with the feet of the pets inside the sock bottom, have a function of massage when the pets are walking Furthermore, the plastic anti-skid points are soft, environmentally friendly and non-toxic as they are made of silicone rubber.

Although the foregoing solution solves the current problems to some extent, the following deficiencies still exist: first, as the waterproof performance of the above mentioned sock is poor, such sock may absorb moisture when residual water is left on the floor to keep the feet of the pets in a humid environment, which may make the pets feel unconformable and encourage the growth of bacteria; and second, as the pet sock is usually woven by yarns, although plastic anti-skid points are provided, the sock may be stuck with foreign materials during the walking of the pets and is likely to be worn out or hooked because the sock bottom is not completely wrapped by such plastic anti-skid points. In addition, existing pet sock is likely to slide off the feet of the pets during their walking and cannot be fastened to the leg of the pet. This may stumble and injure the pets during their walking and wear the sock out. On the other hand, pet sock in the prior arts is poor in anti-skid performance. Especially, when walking on the wet ground, pets wearing such sock are more likely to slip and fall.

### SUMMARY OF THE INVENTION

An object of the present invention in view of the above problem is to provide a pet sock with rational design, simple structure and good waterproof performance.

Another object of the present invention in view of the above problem is to provide an easily-implemented method for manufacturing pet sock with high-quality and good waterproof performance.

To achieve the above objects, the present invention employs the following technical solution. A pet sock is provided, including a sock body, a sock bottom for accommodating a foot of a pet which is communicated with the sock body, and a sock opening provided on the sock body for a foot of a pet to get in or out, wherein an elastic waterproof layer made of an elastic waterproof material is compounded on an outer side of the sole of the sock bottom.

As the elastic waterproof layer is provided, water penetration may be avoided effectively, which enhances comfort and contributes to good health. In addition, due to the elasticity of the elastic waterproof layer, the pet sock may adapt to feet of pets in different sizes and thus have a broad application range. On the other hand, the elastic waterproof layer further protects the pet sock, thereby improving the wear resistance while avoiding sticking with foreign materials and avoiding damages. In order to make the waterproof pet sock more beautiful, various patterns may be provided on the sock body. In addition, the waterproof pet sock may be designed in various shapes depending upon the kind of pets. The elastic waterproof material may be made of any one of PVC, PU, rubber, silicon and latex.

In the foregoing pet sock, the elastic waterproof layer wraps the sole of the whole sock bottom and extends upward to form a lateral surrounding portion; and the lateral surrounding portion wraps the outside of the whole sock body or partially wraps the outside of the sock body. The lateral surrounding portion may further improve the waterproof performance and avoid water penetration from the lateral sides of the pet sock. The pet sock, in which the lateral surrounding portion wraps the outside of the whole sock body, has better waterproof performance, better damage resistance performance and a longer service life; furthermore, the manufacturing thereof is convenient. In case that the lateral surrounding portion partially wraps the outside of the sock body, the manufacturing cost is lower, and both waterproof and air permeability are guaranteed.

In the forgoing pet sock, an anti-skid structure is provided on the underside of the elastic waterproof layer. The anti-skid structure may effectively improve the stability of pets' when they are walking on outdoor wet pavements and icy/snowy pavements.

In the forgoing pet sock, the anti-skid structure includes a cushion in the form of a sheet, with a concave-convex structure provided on the underside of the cushion; or, the anti-skid structure is a concave-convex stripe formed on the underside of the elastic waterproof layer and is integrated with the elastic waterproof layer.

In the forgoing pet sock, the cushion is fixed onto the elastic waterproof layer by binding or melting; and the concave-convex structure includes any one of or a combination of protruding points, ridges, bumps and protruding rings, which are distributed on the underside of the cushion.

In the forgoing pet sock, an anti-slide-off structure is provided on the sock body, and a shield structure that can shield the anti-slide-off structure is also provided on the sock body. Certainly, the anti-slide-off structure herein may be of another structure, for example, a tightening rope, an elastic band, a button fastener, etc.

In the forgoing pet sock, the anti-slide-off structure is fixedly or detachably connected to the middle upper part of the sock body; the anti-slide-off structure includes a garter provided on the sock body, which surrounds the sock body and enables the sock body to cling to the leg of the pet. The detachable connection of the anti-slide-off structure allows the anti-slide-off structure to be detached if not needed, so that the use is more flexible and convenient.

In the forgoing pet sock, the shield structure includes a shield sleeve provided on and integrated with the sock body, the shield sleeve shields the anti-slide-off structure after being turned over; and a decorative structure, which is to be located on the outside after the shield sleeve is turned over, is provided on the inside of the shield sleeve. Certainly, the shield structure herein may be implemented in other solutions, for example, an annular shield sleeve separated from the sock body, a shield sleeve or shield belt detachably fixed onto the sock body, etc. The shield sleeve, when not turned over, may extend the length of the sock body so that the sock body may be used as pet stockings; and when turned over, it may shield the anti-slide-off structure and keeps the pet feet warm. The decorative structure may be varied to make the pet sock more beautiful. The shield sleeve may be elastic in order to wrap the decorative structure better.

In the forgoing pet sock, one end of the garter is fixed onto the sock body and the other end thereof is a free end, wherein a first positioning member is provided at the free end of the garter, a second positioning member is provided on the garter, and the first positioning member and the second positioning member are connected to each other; or the middle part of the garter is fixed onto the sock body, wherein a third positioning member is provided at one end of the garter, a fourth positioning member is provided at the other end of the garter, and the third and fourth positioning members are connected to each other. The first and second positioning members are the first and second magic tapes respectively, can be fitted into each other. The first and second positioning members may be of other structures, such as buttons and buttonholes, zippers, snap fasteners, etc. Similarly, the same solution of the first and second positioning members may be applicable to the third and fourth positioning members.

The method for manufacturing the pet sock includes the following steps of:

A, manufacturing a sock: weaving a sock main body with yarns, the sock main body including a sock body, a sock bottom for accommodating a foot of a pet which is communicated with the sock body, and a sock opening for a foot of a pet to get in or out being provided on the sock body;

B, dipping: putting a liquid elastic waterproof material in a vessel, sheathing the prepared sock main body over a die in a same shape as a foot of a pet, dipping the die sheathed with the sock main body into the elastic waterproof material, and dipping a part of or the whole sock main body into the liquid elastic waterproof material;

C, drying and forming: after the dipping is finished, putting the sock main body on a heating device, drying it to form an elastic waterproof layer, and then taking the sock main body off the die; and

D, processing an anti-slide-off structure and a shield structure: fixing a garter onto the middle upper part of the sock body directly or detachably, so that the garter can surround the sock body and enable the sock body to cling to the leg of the pet, wherein a shield sleeve, integrated with the sock body, is formed above or below the garter, and a decorative structure, which can shield the garter after the shield sleeve is turned over, is provided on the shield sleeve.

Compared with the prior arts, the pet sock and manufacturing method thereof have the following advantages: the design is rational and the structure is simple; as an anti-slide-off structure is provided, the sock can be secured onto the leg of the pet and are unlikely to slide off; meanwhile, due to the presence of a shield sleeve, the anti-slide-off structure can be shielded, so that the pet sock looks more beautiful and become warmer; in addition, the arrangement of the elastic waterproof layer can provide more comfort and protect the feet of pets from injuries.

### BRIEF DESCRIPTION OF THE DRAWINGS

FIG. 1 is a structural diagram according to embodiment 1 of the present invention;

FIG. 2 is a structural diagram according to embodiment 2 of the present invention;

FIG. 3 is a structural diagram according to embodiment 3 of the present invention;

FIG. 4 is a structural diagram according to embodiment 4 of the present invention, where the anti-slide-off structure is not shielded;

FIG. 5 is a structural diagram according to embodiment 4 of the present invention, where the anti-slide-off structure is shielded;

### REFERENCE SIGNS IN THE DRAWINGS

1—Sock body; 2—Sock bottom; 3—Sock opening; 4—Elastic waterproof layer; 5—Lateral surrounding portion; 6—Anti-skid structure; 7—Cushion; 8—Anti-slide-off structure; 9—Shield structure; 10—Garter; 11—Shield sleeve; 12—First positioning member; 13—Second positioning member; 14—Third positioning member; and 15—Fourth positioning member.

### DETAILED DESCRIPTION OF THE INVENTION

The present invention will be further described in detail as below in specific embodiments with reference to the accompanying drawings.

### Embodiment 1

As shown in FIG. 1, the pet sock each includes a sock body 1, a sock bottom 2 for accommodating a foot of a pet which is communicated with the sock body 1, and a sock opening 3 for a foot of a pet to get in or out being provided on the sock body 1. An elastic waterproof layer 4 made of an elastic waterproof material is compounded on an outer side of the sole of the sock bottom 2. The elastic waterproof layer 4 wraps the bottom of the whole sock bottom 2 and extends upward to form a lateral surrounding portion 5; and the lateral surrounding portion 5 partially wraps the outside of the sock body 1.

As the elastic waterproof layer is provided, water penetration may be avoided effectively, which improves the comfort and also contributes to good health. In addition, due to the elasticity of the elastic waterproof layer, the pet sock may adapt to feet of pets in different sizes and thus has a broad application range. On the other hand, the elastic waterproof layer further protects the pet sock, thereby improving the wear resistance, avoiding sticking with foreign materials and avoiding possible damages. In order to make the waterproof pet sock more beautiful, various patterns may be provided on the sock body. In addition, the waterproof pet sock may be designed in various shapes depending upon the kind of pets. The elastic waterproof material may be made of any one of PVC, PU, rubber, silicon and latex.

### Embodiment 2

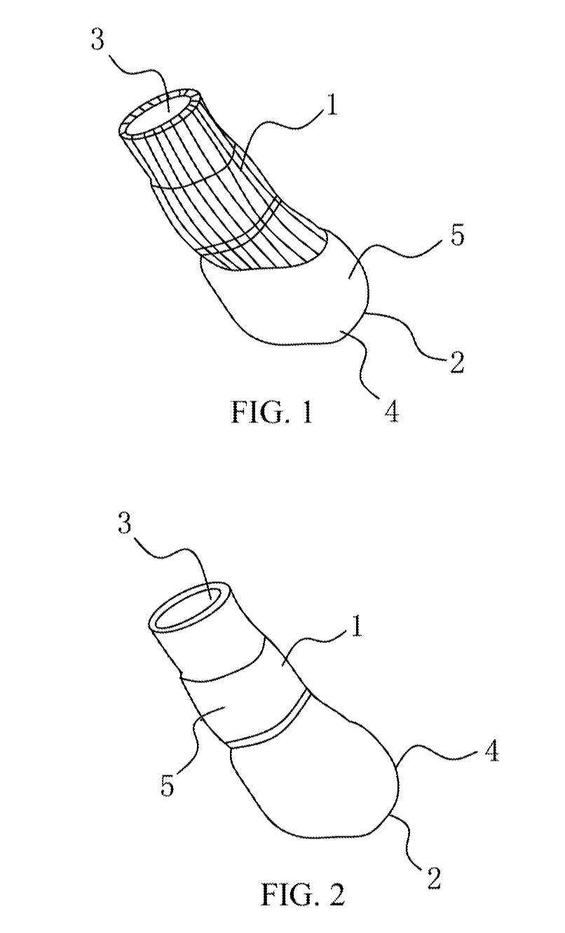

As shown in FIG. 2, in this embodiment, the lateral surrounding portion 5 wraps the outside of the whole sock body 1. The remaining features are the same as those of Embodiment 1 and thus will be not repeatedly described here.

### Embodiment 3

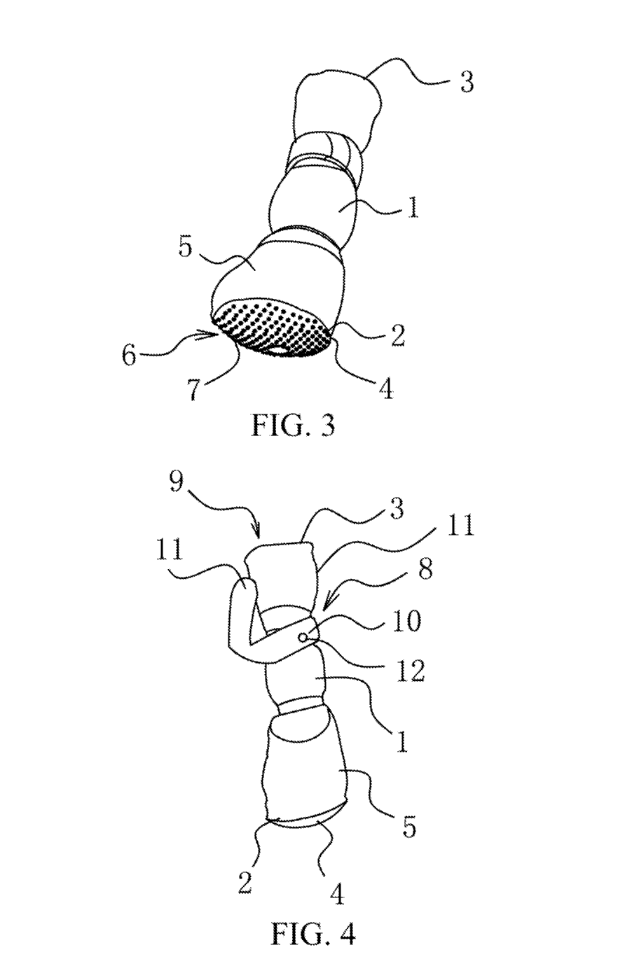

As shown in FIG. 3, in this embodiment, an anti-skid structure 6 is provided on the underside of the elastic waterproof layer 4. The anti-skid structure 6 includes a cushion 7 in the form of a sheet, with a concave-convex structure provided on the underside of the cushion 7; or the anti-skid structure 6 is a concave-convex stripe formed on the underside of the elastic waterproof layer 4 and integrated with the elastic waterproof layer 4. The cushion 7 is fixed onto the elastic waterproof layer 4 by binding or melting; the concave-convex structure includes any one of or a combination of protruding points, ridges, bumps and protruding rings, which are distributed on the bottom of the cushion 7. The remaining features are the same as those of Embodiment 1 or 2 and thus will be not repeatedly described here.

### Embodiment 4

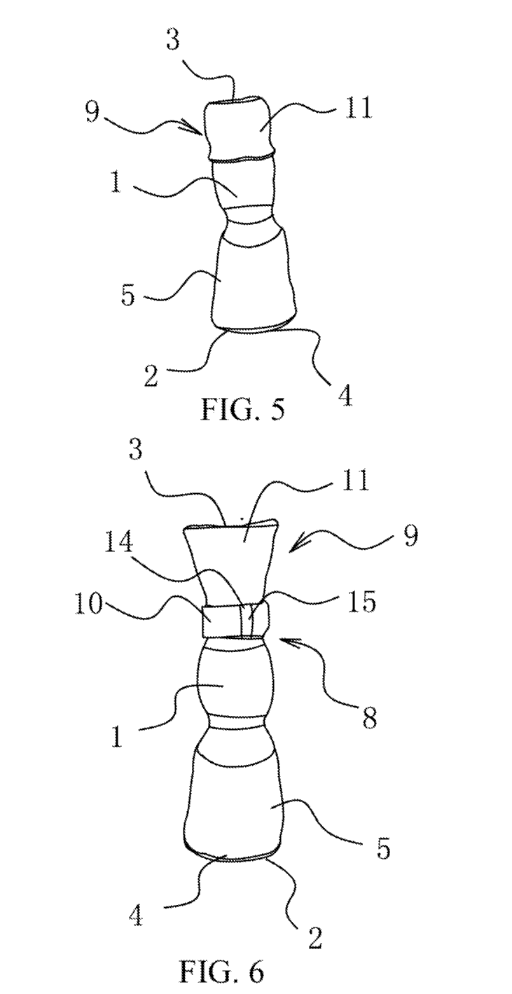

As shown in FIG. 4 and FIG. 5, in this embodiment, an anti-slide-off structure 8 is provided on the sock body 1, and a shield structure 9 that can shield the anti-slide-off structure 8 is also provided on the sock body 1. The anti-slide-off structure 8 is fixedly or detachably connected to the middle upper part of the sock body 1; and the anti-slide-off structure 8 includes a garter 10 provided on the sock body 1, which surrounds the sock body 1 and enables the sock body 1 to cling to the leg of the pet. Certainly, the anti-slide-off structure 8 herein may be of other structures, for example, a tightening rope, an elastic band, a button fastener, etc. The shield structure 9 includes a shield sleeve 11 provided on and integrated with the sock body 1, which shields the anti-slide-off structure 8 after being turned over; and a decorative structure, which is to be located on the outside after the shield sleeve 11 is turned over, is provided inside the shield sleeve 11. Certainly, the shield structure 9 herein may be implemented in other solutions, for example, an annular shield sleeve separated from the sock body, a shield sleeve or shield belt detachably fixed onto the sock body, etc.

The shield sleeve, when not turned over, may extend the length of the sock body so that the sock body may be used as pet stockings; and when turned over, may shield the anti-slide-off structure and keep warm. The decorative structure may be varied for making the pet sock more beautiful. The shield sleeve may be elastic in order to wrap the decorative structure better. The shield sleeve 11 is provided above or below the anti-slide-off structure 8. When located above the anti-slide-off structure 8, the shield sleeve 11 is the cuff portion of the sock body 1, and the cuff portion covers the anti-slide-off structure 8 after turned over downwards; and when located below the anti-slide-off structure 8, the shield sleeve 11 is a tubular body fixed in the middle part of the sock body 1, and the tubular body covers the anti-slide-off structure 8 after turned over upwards.

One end of the garter 10 is fixed onto the sock body 1 and the other end thereof is a free end, wherein a first positioning member 12 is provided at the free end of the garter 10, a second positioning member 13 is provided on the garter 10, and the first and second positioning members 12 and 13 are connected to each other. The first and second positioning members 12 and 13 are the first and second magic tapes respectively, and the first magic tape and the second magic tape are fitted into each other. The first and second positioning members may be of other structures, for example, buttons and buttonholes, zippers, snap fasteners, etc. The remaining features are the same as those of Embodiment 1 or 2 or 3 and thus will be not repeatedly described here.

### Embodiment 5

As shown in FIG. 6, in this embodiment, the middle part of the garter 10 is fixed onto the sock body 1, wherein a third positioning member 14 is provided at one end of the garter 10, a fourth positioning member 15 is provided at the other end of the garter 10, and the third and fourth positioning members 14 and 15 are connected to each other. The same solution of the first and second positioning members may be applicable to the third and fourth positioning members. The remaining features are the same as those of Embodiment 5 and thus will be not repeatedly described here.

The method for manufacturing the pet sock includes the following steps of:

A, manufacturing a sock: weaving a sock main body with yarns, the sock main body including a sock body 1, a sock bottom 2 for accommodating a foot of a pet which is communicated with the sock body 1, and a sock opening 3 for a foot of a pet to get in or out being provided on the sock body 1;

B, dipping: putting a liquid elastic waterproof material in a vessel, sheathing the prepared sock main body over a die in a same shape as a foot of a pet, dipping the die sheathed with the sock main body into the elastic waterproof material, and allowing a part of or the whole sock main body to dip into the liquid elastic waterproof material;

C, drying and forming: after the dipping process is finished, putting the sock main body into a heating device, drying it to form an elastic waterproof layer 4, and then taking the sock main body off the die; and

D, processing the anti-slide-off structure and the shield structure: fixing a garter 10 onto the middle upper part of the sock body 1 directly or detachably, wherein the garter 10 can surround the sock body 1 and enable the sock body 1 to cling to the leg of the pet; a shield sleeve 11, integrated with the sock body 1, is formed above or below the garter 10; and a decorative structure, which can shield the garter 10 after the shield sleeve 11 is turned over, is provided on the shield sleeve 11.

The specific embodiments described herein merely illustrate the spirit of the present invention. For an ordinary person skilled in the art to which the present invention belongs, various modifications or supplementations may be made to the specific embodiments described herein or the specific embodiments described herein may be replaced by similar solutions, without departing from the spirit of the present invention or exceeding the scope defined by the appended claims.

Although the terms have been widely used herein, such as “sock body 1”, “sock bottom 2”, “sock opening 3”, “elastic waterproof layer 4”, “lateral surrounding portion 5”, “anti-skid structure 6”, “cushion 7”, “anti-slide-off structure 8”, “shield structure 9”, “garter 10”, “shield sleeve 11”, “first positioning member 12”, “second positioning member 13”, “third positioning member 14” and “fourth positioning member 15”, the possibility of using other terms is not excluded. The use of these terms is to describe and explain the essence of the present invention more conveniently, and the interpretation of these terms with any additional constraint goes against the spirit of the present invention.

1. Pet socks, each comprising a sock body and a sock bottom for accommodating a foot of a pet, the sock body being communicated with the sock bottom, a welt for a foot of a pet to get in or out being provided on the sock body, wherein an elastic waterproof layer made of elastic waterproof material is compounded on the bottom outside of the sock bottom.

2. The pet socks according to claim 1, wherein the elastic waterproof layer wraps the bottom of the whole sock bottom and extends upward to form a lateral surrounding portion; and the lateral surrounding portion wraps the outside of the whole sock body or partially wraps the outside of the sock body.

3. The pet socks according to claim 2, wherein an anti-skid structure is provided on the bottom of the elastic waterproof layer.

4. The pet socks according to claim 3, wherein in that the anti-skid structure comprises a gasket in the form of sheet, with a concave-convex structure being provided on the bottom of the gasket; or, the anti-skid structure is a concave-convex stripe formed on the bottom of the elastic waterproof layer and integrated with the elastic waterproof layer.

5. The pet socks according to claim 3, wherein the gasket is fixed onto the elastic waterproof layer by binding or hot melting; the concave-convex structure comprises any one of or a combination of more of protruded points, protruded ridges, protruded bumps and protruded rings, which are distributed on the bottom of the gasket.

6. The pet socks according to claim 1, wherein an anti-slide-off structure is provided on the sock body, and a shield structure that can shield the anti-slide-off structure is also provided on the sock body.

7. The pet socks according to claim 6, wherein the anti-slide-off structure is fixedly or detachably connected to the middle upper part of the sock body; and the anti-slide-off structure comprises a garter provided on the sock body, the garter surrounding the sock body circumferentially and enabling the sock body to cling to the legs of pets.

8. The pet socks according to claim 7, wherein the shield structure 9 comprises a shield sleeve provided on and integrated with the sock body, the shield sleeve shielding the anti-slide-off structure after being turned over; and a decorative structure, which is to be located on the outside after the shield sleeve is turned over, is provided on the inside of the shield sleeve.

9. The pet socks according to claim 7, wherein one end of the garter is fixed onto the sock body and the other end thereof is a free end, a first positioning member being provided at the free end of the garter, a second positioning member being provided on the garter, the first positioning member and the second positioning member being connected to each other; or, the middle part of the garter is fixed onto the sock body, a third positioning member being provided at one end of the garter a fourth positioning member being provided at the other end of the garter, third positioning member and the fourth positioning member being connected to each other.

10. The method for manufacturing the pet socks according to claim 1, comprising the following steps of:
A, manufacturing socks: weaving a sock main body with yarns, the sock main body comprising a sock body and a sock bottom for accommodating a foot of a pet, the sock body being communicated with the sock bottom, a welt for a foot of a pet to get in or out being provided on the sock body;
B, dipping: putting the liquid elastic waterproof material in a vessel, sheathing the prepared sock body onto a die in a same shape as a foot of a pet, dipping the die sheathed with the sock body into the elastic waterproof material, and allowing a part of or the whole sock body into the liquid elastic waterproof material;
C, drying and forming: at the end of dipping, putting the sock body into a heating device, drying it to form an elastic waterproof layer, and then taking the sock body off the die;
D, processing the anti-slide-off structure and the shield structure: fixing a garter onto the middle upper part of the sock body directly or detachably, and the garter can surround the sock body circumferentially and enable the sock body to cling to the legs of pets; a shield sleeve, integrated with the sock body, is formed above or below the garter; and a decorative structure, which can shield the garter after the shield sleeve is turned over, is provided on the shield sleeve.
